(19) United States
(12) Patent Application Publication
(10) Pub. No.: US 2013/0106988 A1
(43) Pub. Date: May 2, 2013

(54) COMPOSITING OF VIDEOCONFERENCING STREAMS

(71) Applicants: Joseph Davis, Albany, OR (US); James R. Cole, Albany, OR (US)

(72) Inventors: Joseph Davis, Albany, OR (US); James R. Cole, Albany, OR (US)

(21) Appl. No.: 13/284,711

(22) Filed: Oct. 28, 2011

(51) Int. Cl. H04N 7/15

(52) U.S. Cl. 348/14.09; 348/14.08; 348/E07.083; 348/E07.084

(57) ABSTRACT

Input video streams that are composited video streams for a videoconference are identified. For each of the composited video streams, video images composited to form the composited video streams are identified. A layout for an output composited video stream can be selected, and the output composited video stream representing the video images arranged according to the selected layout can be constructed.

### BACKGROUND

A videoconferencing system can employ a Multipoint Control Unit (MCU) to connect multiple endpoints in a single conference or meeting. The MCU is generally responsible for combining video streams from multiple participants into a single video stream which can be sent to an individual participant in the conference. The combined video stream from an MCU generally represents a composited view of multiple video images from various endpoints, so that a participant viewing the single video stream can see many participants or views. In general, a videoconference may include participants at endpoints that are on multiple networks or that use different videoconferencing systems, and each network or videoconferencing system may employ one or more MCU. If a conference topology includes more than one MCU, an MCU may composite video streams including one or more video streams that have previously been composited by other MCUs. The result of this ‘multi-stage’ compositing can place images of some conference participants in small areas of a video screen while the images of other participants are given an inordinate amount of screen space. This can result in a poor user experience during a videoconference using multi-stage compositing.

### BRIEF DESCRIPTION OF THE DRAWINGS

FIG. 1 is a block diagram of an example of a videoconferencing system including more than one multipoint control unit (MCU).

FIG. 2 shows examples of images represented by composited video streams that MCUs may generate.

FIG. 3 shows an example of an image represented by a composited video stream generated from input video streams including already composited video streams.

FIG. 4 is a flow diagram of an example of a compositing process that decomposes video streams to identify video images and then constructs a composited video stream representing a composite of the video images.

FIG. 5 shows an example of an image represented by a composited video stream that is generated from decomposed video streams and that provides equal display areas to video images.

FIG. 6 shows an example of an image represented by a composited video stream that is generated from decomposed video streams and that uses a user preference to select a layout for video images.

Use of the same reference symbols in different figures may indicate similar or identical items.

### DETAILED DESCRIPTION

A videoconferencing system that creates a composited video stream from multiple input video streams can analyze the input video streams to determine whether any of the input video streams was previously composited or contains filler areas. A set of video images associated with endpoints can thus be generated from the input video streams, and the number of video images generated will generally be greater than or equal to the number of input video streams. A compositing operation for a videoconference can then act on the video images in a user specifiable manner to construct a composited video stream representing a composite of the video images. A video stream composited in this manner may improve a videoconferencing experience by providing a more logical, more useful, or more aesthetically desirable video presentation. For example, the compositing operation can devote equal area to each of the separated video images, even when some of the video images in the input streams are smaller than others. Filler areas from the input video streams can also be removed to make more screen space available to the video images. A multi-stage compositing processing can thus give each participant or view in a videoconference an appropriately sized screen area and appropriate position even when the participant or view was previously incorporated in a composited video image.

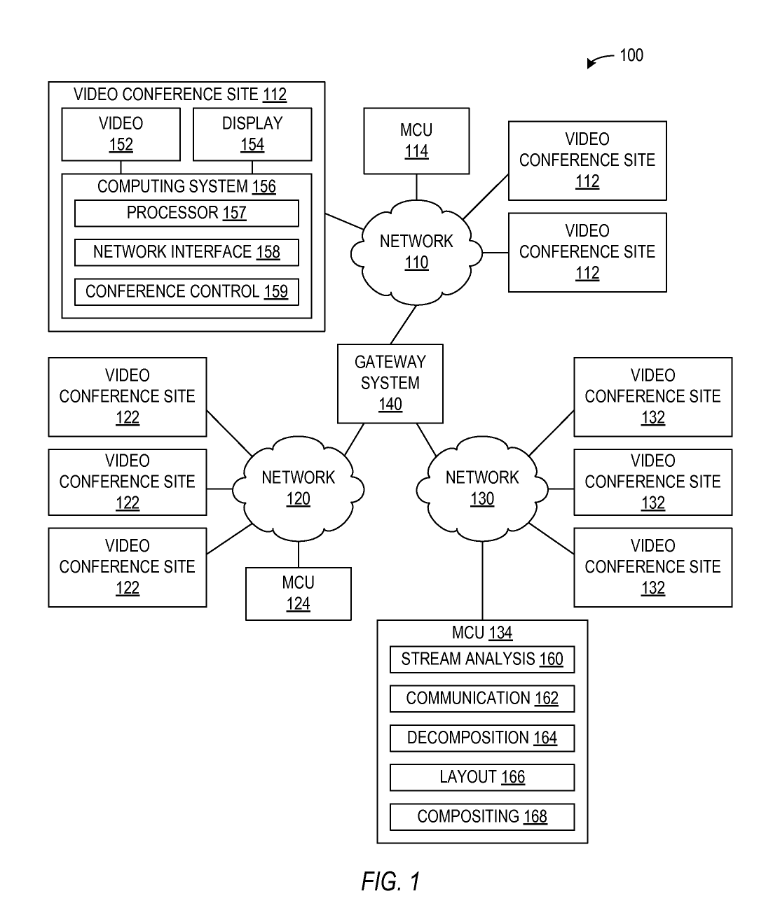

FIG. 1 is a block diagram of a videoconferencing system 100 having a configuration that includes multiple networks 110, 120, and 130. Each network 110, 120, and 130 may be the same type of network, e.g., a local area network (LAN) employing a packet switched protocol, or networks 110, 120, or 130 may be different types of networks. Videoconferencing on system 100 may involve communication of audio and video between conferencing endpoints 112, 122, and 132, and videoconferencing system 100 may employ a standard communication protocol for communication of audio-video data streams. For example, the H.323 protocol promulgated by the ITU Telecommunication Standardization Sector (ITU-T) for audio-video signaling over packet switched networks is currently a common protocol used for videoconferencing.

Each of networks 110, 120, and 130 in system 100 further provides separate videoconferencing capabilities (e.g., a videoconferencing subsystem) that can be separately employed on network 110, 120, or 130 for a videoconference having participants on only the one network 110, 120, or 130. The videoconferencing subsystems associated with networks 110, 120, and 130 can alternatively be used cooperatively for a videoconference involving participants on multiple networks. The videoconferencing systems associated with individual networks 110, 120, and 130 may be the same or may differ. For example, the separate videoconferencing systems may implement different protocols or have different manufacturers or providers. In general, even when different providers implement videoconferencing systems based on the same protocol, e.g., the H.323 standard, the providers of the videoconferencing systems often provide different implementations of such standards, which may necessitate the use of a gateway device to translate the call signaling and data streams between endpoints of videoconferencing systems of different providers. In the embodiment of FIG. 1, networks 110, 120, and 130 are interconnected through a gateway system 140, which may require multiple network gateways or gateways able to convert between the signaling techniques that may be used in the videoconferencing subsystems. The specific types of networks 110, 120, and 130, videoconferencing subsystems, and gateway system 140 employed in system 100 are not critical for the present disclosure, and many types of networks and gateways are known in the art and may be developed.

A videoconferencing subsystem associated with network 110 contains multiple videoconferencing sites or endpoints 112. Each videoconferencing site 112 may be, for example, a conference room containing dedicated videoconferencing equipment, a workstation containing a general purpose computer, or a portable computing device such as a laptop computer, a pad computer, or a smartphone. For ease of illustration, FIG. 1 shows components of only one videoconference site 112. However, each videoconference site 112 generally includes a video system 152, a display 154, and a computing system 156. Video system 152 operates to capture or generate one or more video streams for conference site 112. For example, video system 152 for a conference room may include multiple cameras or other video devices that capture video images of people such as presenters, specific members of an audience, or the audience in general or presentation devices such as whiteboards. Video system 152 could also or alternatively generate a video stream from a computer file such as a presentation or a video file stored on a storage device (not shown).

Each conferencing site 112 further includes a computing system 156 containing hardware such as a processor 157 and hardware portions of a network interface 158 that enables videoconference site 112 to communicate via network 110. Computing system 156, in general, may further include software or firmware that processor 157 can execute. In particular, network interface 158 may include software or firmware components. Conferencing control software 159 executed by processor 157 may be adapted for the videoconferencing subsystem on network 110. For example, processor 157 may execute routines from conference control software 159 to produce one or more audio-video data stream including a video image from video system 152 and to transmit the audio-video data stream. Similarly, processor 157 may execute routines from software 159 to receive an audio-video data stream associated with a videoconference and to produce video on display 154 and sound through an audio system (not shown).

The videoconferencing subsystem associated with network 110 also includes a multipoint control unit (MCU) 114 that communicates with videoconference sites 112. MCUs 114 can be implemented in many different ways. FIG. 1 shows MCU 114 as a separate dedicated system, which would typically include software running on specialized processors (e.g., digital signal processors (DSPs)) with custom hardware internal interconnects. MCU 114, when implemented using dedicated hardware, can provide high-performance. MCU 114 could alternatively be implemented in software executed on one or more endpoints 112 or on a server (not shown). In general such software implementations of MCU 114 provide lower cost and lower performance than an implementation using dedicated hardware.

MCU 114 may combine video streams from videoconference sites 112 (and optionally video streams that may be received through gateway system 140) into a composited video stream. The composited video stream that MCU 114 produces can be a single video stream representing a composite of multiple video images from endpoints 112 and possibly video streams received through gateway system 140. In general, MCU 114 may produce different composited video streams for different endpoints 112 or for transmission to another videoconference subsystem. For example, one common feature of MCUs is to remove a participant's own image from the composited image sent to that participant. Thus, each endpoint 112 on network 114 could have a different composited video stream. MCU 114 could also vary the composited video streams for different endpoints 112 to change characteristics such as the number of participants shown in the composited video or the aspect ratio or resolution of the composited video. In particular, MCU 114 may take into account the capabilities of each endpoint 112 or other MCU 124 or 134 when composing an image for that endpoint 112 or remote MCU.

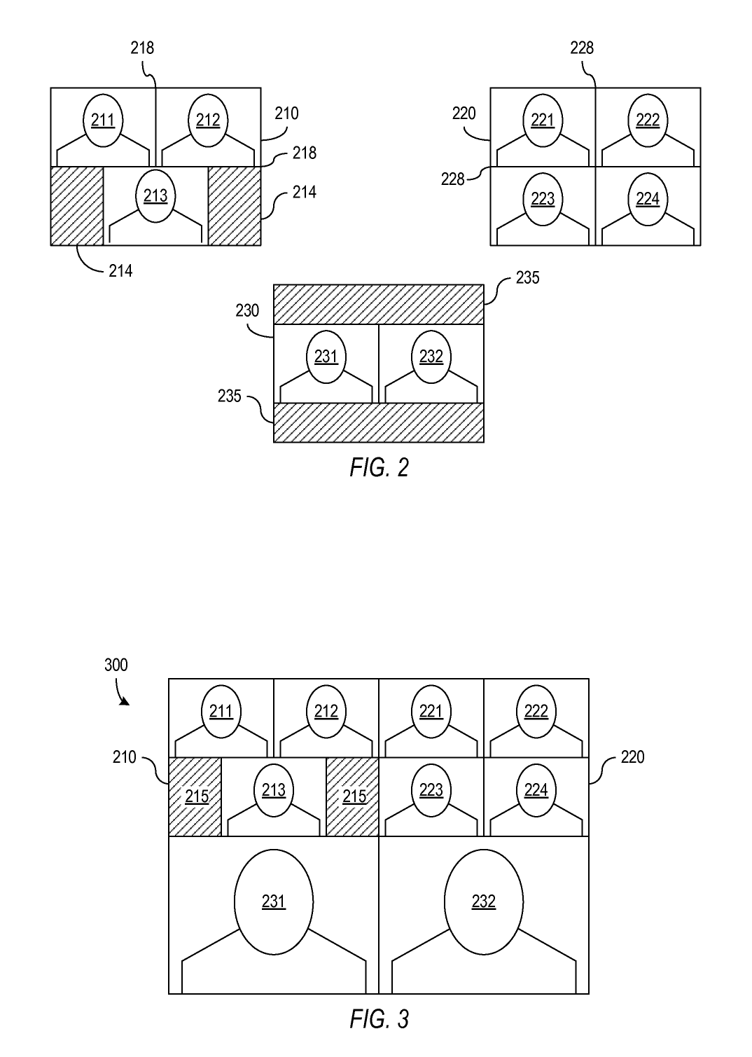

FIG. 2 shows an example of a composited video image 210 that MCU 114 may create from multiple video streams received from end points 112 for transmission to another videoconferencing subsystem. In the example of FIG. 2, composited video stream 210 includes three video images 211, 212, and 213, which may be from three endpoints 112 currently participating in a videoconference. The arrangement of video images 211, 212, and 213 in composited video image 210 may depend on the number of videoconference participants using the videoconferencing system associated with MCU 114. For the example of composited image 210, there are three participants using the videoconferencing subsystem associated with MCU 114, and each of the three video images 211, 212, and 213 occupy the equal area in composited image 210. In the illustrated arrangement, the aspect ratio of each video image 211, 212, and 213 is preserved, which results in composite video image 210 containing filler areas 214 (e.g., gray or black regions) because the three images 211, 212, and 213 cannot be arranged to fill the entire area of composite video image 210 without stretching or distorting at least one of the images 211, 212, or 213. Similar filler areas may also result in a video image from letter boxing or cropping of video images when video images with different aspect ratios are composited in the same composite image.

A videoconferencing subsystem associated with MCU 124 operates on network 120 of FIG. 1 and includes videoconferencing sites 122 that may be similar or identical to videoconference sites 112 as described above. The videoconferencing system on network 120 may implement the same videoconferencing standard (e.g., the H.323 protocol) but may have implementation differences from the videoconferencing system on network 110. From video streams of videoconference participants or endpoints 122, MCU 124 may generate a composited video stream representing a composite video image 220 illustrated in FIG. 2. In this example, composited video image 220 contains four video images 221, 222, 223, and 224 that may be arranged in composited video image 220 without the need for filler areas.

A videoconferencing subsystem associated with MCU 134 operates on network 130 of FIG. 1 and similarly includes videoconferencing sites 132 that may be similar or identical to videoconference sites 112 as described above. From video streams of videoconference participants or endpoints 132, MCU 134 may generate a composited video stream representing a composite video image 230 illustrated in FIG. 2 for transmission to another MCU 114 or 124. In this example, composited video image 230 contains two video images 231 and 232 that are arranged with dead space or filler 235.

MCUs 114, 124, and 134 may create respective composited video streams representing composite video image 210, 220, and 230 for transmission to external videoconference systems as described above. In the example of FIG. 2, MCU 134 may receive from MCU 114 a composited video stream representing composite video image 210 and receive from MCU 124 a composited video stream representing composite video image 220. MCU 134 also receives video streams from endpoints 132 that are participating in the videoconference, e.g., video streams respectively representing video images 231 and 232 in the example of FIG. 2.

Some MCUs allow compositing operations using video streams that may have been composited by another MCU, but the resulting image may have individual streams at varying sizes without a good cause. For example, FIG. 3 illustrates a composite video image that gives each input video stream an equal area in a composite image 300. As a result, participants' video images 211, 212, and 213 in composite video image 210 and participants' video images 221, 222, 223, and 224 in composite video image 220 are assigned much less area than video images 231 and 232 that are in the videoconferencing system associated with MCU 134. Composite image 300 also includes dead space or filler areas 214 that were inserted in an earlier compositing operation.

FIG. 1 shows MCU 134 having structure that permits improvements in the layout of video images in a composited image. In particular, MCU 134 includes a stream analysis module 160, a communication module 162, a decomposition module 164, a layout module 166, and a compositing module 168. MCU 134 can use stream analysis module 160 or communication module 162 to identify input video streams that are composited video streams either by analyzing the video streams or by communicating with a source of the video streams. Decomposition module 164 can then decompose the composited video stream into separate video images, and layout module 166 can select a layout for an output composited video stream representing a composite of the video images. Compositing module 168 can then generate the output composited video stream representing the video images arranged in the selected layout. As described further below, MCU 134 may thus be able to improve the video display for participants at endpoints on network 130. In a different configuration of system 100, each of MCUs 114 or 124 may be the same as MCU 134 or may be a conventional MCU that lacks the capability to decompose composited video streams. MCUs that lack the capability to perform multi-stage compositing including decomposing video streams as described herein may be referred to as legacy MCUs.

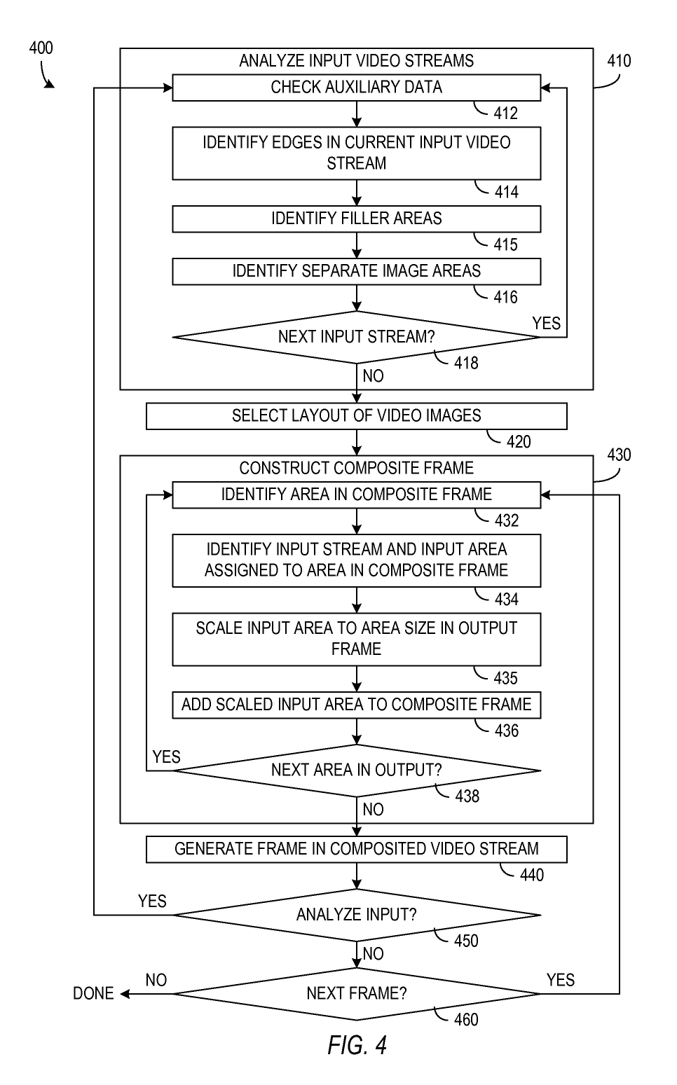

FIG. 4 is a flow diagram of a compositing process 400 that can provide a multi-stage composited video stream representing a more logical or aesthetic presentation of video during a videoconference. Process 400 may be performed by an MCU or other computing system that may receive video streams from end points or from other MCUs that may perform compositing operations. As an example, the process of FIG. 4 is described for the particular system of FIG. 1 when MCU 134 is used in performance of process 400. In this illustrative example, MCU 134 receives video streams from endpoints 132 and receives composited video streams from MCUs 114 and 124. It may be noted that each MCU 114 or 124 may be able to similarly implement process 400 or may be a legacy MCU, the input video streams for process 400 can vary widely from the illustrative example, and process 400 can be executed in videoconferencing systems that are different from videoconferencing system 100.

Process 400 begins with a process 410 of analyzing the input video streams to determine the number of video images or sub-streams composited in each input video stream and the respective areas corresponding to the video images. In particular, each video stream coming into a compositing stage can be evaluated to determine if the video stream is a composited stream. The analysis can consider the content of the video stream as well as other factors. For example, the source of the video stream can be considered if particular sources are known to provide a composited video stream or known to not provide a composited video stream. In some videoconferencing systems, the video streams received directly from at least some endpoints 134 may be known to represent a single video image, while video streams received from other MCUs may or may not be composited video streams. Video streams that are known to not be composited do not need to be further evaluated and can be assumed to contain a single video image occupying the entire area of each frame of video.

With process 400, an MCU generating a composited video stream may add flags or auxiliary data to the video stream to identify the video stream as being composited and even identifying the number of video images and the areas assigned to the video images in each composited frame. In step 412, MCU 134 can check for auxiliary data that MCU 114 or 124 may have added to an input video stream to indicate that the video stream is a composited video stream. Similarly, in some configurations of videoconferencing system 100, MCU 134 and MCU 114 or 124 may be able to communicate via a proprietary application program interface (API) to specify the compositing layout in the previous stage, which could remove the need to do sophisticated analysis of a composited video stream because the sub-streams are known. A videoconferencing standard may also provide commands associated with choosing particular configurations that MCU 134 could send to MCU 114 or 124 to define the previous stage compositing behavior in MCU 114 or 124. This could allow MCU 134 to identify the video images or sub-streams without additional analysis of the incoming stream from MCU 114 or 124. In other configurations, MCU 114 or 124 may be a legacy MCU that is unable to include auxiliary data when a video image is composited, unable to communicate layout information through an API, and unable to receive compositing commands from MCU 134.

A composited video stream can be identified from the image content of the video stream. For example, a composited video data stream will generally include edges that correspond to a transition from an area corresponding to one video image to an area corresponding to another video image or a filler area, and in step 414, MCU 134 can employ image processing techniques to identify edges in frames represented by an input video stream. The edges corresponding to the edges of video images may be persistent and may occur in most or every frame of a composited video stream. Further, the edges may be characteristically horizontal or vertical (not at an angle) and in predictable locations such as lines that divide an image into halves, thirds, or fourths, which may simplify edge identification. In step 414, MCU 134 may, for example, scan each frame for horizontal lines that extend from the far left of a frame to the far right of the frame and then scan for vertical lines that extend from the top to the bottom of the frame. Horizontal and vertical lines can thus identify a simple grid containing separate image areas. More complex arrangements of image areas could be identified from horizontal or vertical lines that do not extend across a frame but instead end at other vertical or horizontal lines. A recursive analysis of image areas thus identified could further detect images in a composited image resulting from multiple compositing operations, e.g., if image 300 of FIG. 3 were received as an input video stream.

MCU 134 in step 415 also checks the current video stream for filler areas. The filler areas may, for example, be areas of constant color that do not change over time. Such filler areas may be relatively large, e.g., covering an area comparable or equal to the area of a video image or may be a frame that an MCU 114 or 124 adds around each video image when compositing video images. Further, the MCU 114 or 124 providing an input video stream may add frames around each of the video images composited. The frames can further have consistent characteristics such as a characteristic width in pixels or a characteristic color, and MCU 134 can use such known characteristics of frames to simplify identification of separate video images. Further, a convention can be adopted by MCU 114, 124, and 134 to use specific types of frames to intentionally simplify the task of identifying areas associated with separate video images in a composited video stream.

MCU 134 in step 416 can use the information regarding the locations of edges or filler areas to identify separate image areas in a composited input stream. For example, analysis of one of more frames representing a composite video image 210 of FIG. 2 may identify filler areas 214 and image dividing edges 218. MCU 132 could then infer that the video stream associated with image 210 is a composited video stream containing three video images or sub-streams. MCU 134 can further determine the locations, sizes and aspect ratios for the respective video images identified in the current input video stream and then record or store the determined sub-stream parameters for later use. In step 418, MCU 134 can determine if there are any other input video streams that need to be analyzed and start the analysis process 410 again if another of the input video streams may be a composited video stream.

As a result of repeating analysis process 410, a determination of the total number of video images represented by all of the input video streams may be determined. In particular, each composited video stream may represent multiple video streams. MCU 134 in step 420 can use the total number of video images and other information about the composited video stream or streams to determine an optimal layout for the current compositing stage performed by MCU 134 in process 400. An optimal layout may, for example, give each participant in a meeting an equal area in the output composited image.

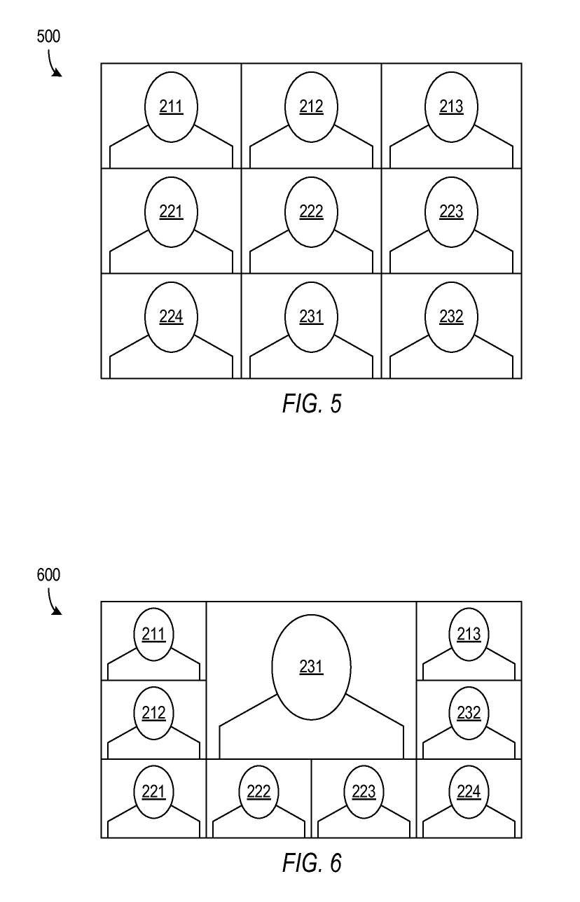

FIG. 5 shows an example of a layout 500 for a composited stream that MCU 134 may use if video streams representing video images 210, 220, 231, and 232 are input to MCU 134. In this example, MCU 134 receives composited video streams representing composite images 210 and 220 respectively from MCUs 114 and 124 and receives video streams representing video images 231 and 232 directly from two endpoints 132. Analysis in step 410 identifies three areas in image 210 corresponding to video images or sub-streams 211, 212, and 213, four areas in image 220 corresponding to video images or sub-streams 221, 222, 223, and 224, one area in image 231, and one area in image 232. Accordingly, there are a total of nine input video image areas, and layout 500, which provides nine areas of the same size, can be assigned to video images 211, 212, 213, 221, 222, 223, 224, 231, and 232. More generally, layouts providing equal areas to each video image may be predefined according to the number of participants and selected when the total number of images to be displayed is known.

The layout selected in step 420 may further depend on user preferences and other information such as the content or a classification of the video images or the capabilities of the endpoint 132 receiving the composited video stream. For example, a user preference may allot more area of a composited image to the video image of a current speaker at the videoconference, a whiteboard, or a slide in a presentation. The selection of the layout may define areas in an output video frame and map the video images to respective areas in the output frame. FIG. 6 shows an example in which one of the nine images identified for the example of FIG. 2 is intentionally given more area in a layout 600. For example, a video image 231 may have been identified as being the current speaker at a videoconference and be given more area, while participants that may currently be less active are in smaller areas. Another factor that MCU 134 may used to select a layout is the space that an endpoint 134 has allotted for display, which may be defined by the size, the aspect ratio, and the number of screens at the endpoint 134. For example, step 420 may select a layout for an endpoint 134 with three large, wide screen displays that is different from the layout selected for a desktop endpoint 134 with one standard screen. The types of layouts that may be available or selected can vary widely so that a complete enumeration of variations is not possible. Layouts 500 and 600 of FIGS. 5 and 6 are provided here solely as relatively simple examples.

Compositing process 400 uses the selected layout and the identified video images or sub-stream in a process 430 that constructs each frame of an output composited video stream. Process 430 in step 432 identifies an area that the selected layout defines in each new composited frame. Step 434 further uses the layout to identify an input data stream and possibly an area in the input data stream that is mapped to the identified area of the layout. If the input data stream is not composited, the input area may be the entire area represented by the input data stream. If the input data stream is a composited video stream, the input area corresponds to a sub-stream of the input data stream. In general, the input area will differ in size from the assigned area in the layout, and step 435 can scale the image area from the input data stream to fit properly in an assigned area of the layout. The scaling can increase or decrease the size of the input image and may preserve the aspect ratio of the input area or stretch, distort, fill, or crop the image from the input area if the aspect ratios of the input area and the assigned layout area are different. In step 436, the scaled image data generated from the input area or video sub-stream can be added to a bit map of the current frame being composited, and step 438 can determine whether the composited frame is complete or whether there are areas in the layout for which image data has not been added. When an output frame is finished, MCU 134 in step 440 can encode the new composite frame as part of a composited video stream in compliance with the videoconferencing protocol being employed.

The areas associated with video images or sub-streams in the input video streams may remain constant over time unless a participant joins or leaves a videoconference. In a step 450, MCU 134 decides whether one or more of the input data streams should be analyzed to detect changes, and if so, process 400 branches back to analysis process 410. Such analysis can be performed periodically or in response to an indication of a change in the videoconference, e.g., termination of an input video stream or a change in video conference information. A change in user preference from a recipient of the output composited video stream from process 134 might also trigger analysis of input video streams in process 410 or selection of a new layout in step 420. Additionally, video conferencing events such as a change in the speaker or presenter may occur that trigger a change in the layout or a change in the assignment of video images to areas in the layout. If such an event occurs, process 400 may branch back to layout selection step 420 or back to analysis process 410. If new analysis is not performed and the layout is not changed, process 400 can execute step 460 and repeat process 430 to generate the next composited frame using the previously determined analysis of the input video streams and the selected layout of video images.

Implementations may include computer-readable media, e.g., a non-transient media, such as an optical or magnetic disk, a memory card, or other solid state storage storing instructions that a computing device can execute to perform specific processes that are described herein. Such media may be or may be contained in a server or other device connected to a network such as the Internet that provides for the downloading of data and executable instructions.

Although particular implementations have been disclosed, these implementations are only examples and should not be taken as limitations. Various adaptations and combinations of features of the implementations disclosed are within the scope of the following claims.

What is claimed is:

1. A videoconferencing process comprising:
receiving a plurality of video streams at a processing system;
determining with the processing system which of the video streams are composited video streams;
for each of the composited video streams, identifying video images composited to form the composited video streams;
selecting a layout for an output composited video stream; and
constructing the output composited video stream representing the video images arranged according to the layout selected.

2. The process of claim 1, wherein determining which of the video streams are composited video streams comprises analyzing the video streams to identify which of the video streams are composited video streams.

3. The process of claim 2, wherein analyzing the video streams comprises detecting edges in frames represented by one of the video streams.

4. The process of claim 2, wherein analyzing the video streams comprises detecting filler areas in frames represented by one of the video streams.

5. The process of claim 2, wherein analyzing the video stream comprises decoding auxiliary data transmitted from a source of one of the video streams to determine whether that video stream is composited.

6. The process of claim 1, wherein determining which of the video streams are composited video streams comprises sending a communication between a source of one of the video streams and the processing system.

7. The process of claim 1, wherein selecting the layout comprises selecting the layout using a total number of the video images represented in the composited video streams and video images represented in video streams that are not composited.

8. The process of claim 7, wherein selecting the layout comprises assigning equal display areas represented in the output composited video stream for each of the video images.

9. The process of claim 7, wherein selecting the layout further comprises using a user preference to distinguish among possible layouts.

10. A non-transient computer readable media containing instructions that when executed by the processing system perform a videoconferencing process comprising:
receiving a plurality of video streams at the processing system;
determining with the processing system which of the video streams are composited video streams;
for each of the composited video streams, identifying video images composited to form the composited video streams;
selecting a layout for an output composited video stream; and
constructing the output composited video stream representing the video images arranged according to the layout selected.

11. A videoconferencing system comprising a computing system that includes:
an interface adapted to receive a plurality of input video streams; and
a processor that executes:
a stream analysis module that determines which of the input video streams are composited video streams and for each of the composited video streams, identifies video images composited to form the composited video streams;
a layout module that selects a layout for an output composited video stream; and
a compositing module that constructs the output composited video stream representing the video images arranged according to the layout selected.

12. The system of claim 11, wherein the computing system comprises a multipoint control unit.

13. The system of claim 11, wherein the stream analysis module analyzes images represented by the input video streams to identify which of the input video streams are composited video streams.

14. The system of claim 11, wherein the analysis module comprises a decoder of auxiliary data transmitted from a source of one of the input video streams, wherein the analysis module determines whether the input video stream from the source is composited by decoding the auxiliary data.

15. The system of claim 11, wherein the layout module selects the layout using a total number of the video images represented in the composited video streams and video images represented in video streams that are not composited.
